(19) United States
(12) Patent Application Publication
(10) Pub. No.: US 2023/0340920 A1
(43) Pub. Date: Oct. 26, 2023

(54) EXHAUST GAS CONTROL APPARATUS AND EXHAUST GAS CONTROL METHOD FOR INTERNAL COMBUSTION ENGINE

(71) Applicant: TOYOTA JIDOSHA KABUSHIKI KAISHA, Toyota-shi (JP)

(72) Inventor: Keiichiro AOKI, Sunto-gun (JP)

(73) Assignee: TOYOTA JIDOSHA KABUSHIKI KAISHA, Toyota-shi (JP)

(21) Appl. No.: 18/170,226

(22) Filed: Feb. 16, 2023

(30) Foreign Application Priority Data
Apr. 25, 2022 (JP) 2022-071674

(51) Int. Cl. F02D 41/14

(52) U.S. Cl. CPC F02D 41/1475; F02D 41/1454; F02D 2041/147; F02D 2250/36

(57) ABSTRACT

An exhaust gas control apparatus for an internal combustion engine includes: a catalyst disposed in an exhaust passage of the internal combustion engine and capable of occluding oxygen; an air-fuel ratio sensor that detects the air-fuel ratio of an out-flow exhaust gas that flows out of the catalyst; and an air-fuel ratio control device that controls the air-fuel ratio of an in-flow exhaust gas that flows into the catalyst. The air-fuel ratio control device starts slightly rich control in which the air-fuel ratio of the in-flow exhaust gas is controlled such that the air-fuel ratio of the out-flow exhaust gas is maintained at a slightly rich setting air-fuel ratio that is richer than a stoichiometric air-fuel ratio, when the air-fuel ratio of the out-flow exhaust gas is reduced to be equal to or less than a rich-side switching air-fuel ratio that is richer than the stoichiometric air-fuel ratio.

### CROSS-REFERENCE TO RELATED APPLICATION

This application claims priority to Japanese Patent Application No. 2022-071674 filed on Apr. 25, 2022, incorporated herein by reference in its entirety.

### BACKGROUND

### 1. Technical Field

The present disclosure relates to an exhaust gas control apparatus and an exhaust gas control method for an internal combustion engine.

### 2. Description of Related Art

It has hitherto been known to dispose a catalyst that can occlude oxygen in an exhaust passage of an internal combustion engine to control HC, CO, NOx, etc. in an exhaust gas in the catalyst. In internal combustion engines described in Japanese Unexamined Patent Application Publication No. 2008-128110 (JP 2008-128110 A) and Japanese Unexamined Patent Application Publication No. 09-126012 (JP 09-126012 A), the air-fuel ratio of an exhaust gas is controlled based on an output from an air-fuel ratio sensor disposed downstream of a catalyst, in order to enhance the exhaust gas control performance of the catalyst.

When oxygen is depleted in the catalyst, however, a water gas shift reaction and a steam reforming reaction are caused, and hydrogen generated through these reactions flows out of the catalyst. As a result, an error is caused in the output from the air-fuel ratio sensor disposed downstream of the catalyst. JP 2008-128110 A describes calculating an error in the output from the air-fuel ratio sensor due to the hydrogen generated in the catalyst and setting a target air-fuel ratio so as to cancel out the output error.

### SUMMARY

However, the technique described in JP 2008-128110 A is based on the assumption that hydrogen is always generated in the catalyst, and air-fuel ratio control is not performed in accordance with the state of the catalyst. Therefore, exhaust emission may be degraded when the state of the catalyst is varied in accordance with the operation state of the internal combustion engine.

Thus, the present disclosure provides a technique of suppressing degradation in exhaust emission by performing air-fuel ratio control in accordance with the situation of generation of hydrogen in a catalyst when the air-fuel ratio of an exhaust gas is controlled based on an output from an air-fuel ratio sensor disposed downstream of the catalyst.

A first aspect of the present disclosure relates to an exhaust gas control apparatus for an internal combustion engine including a catalyst, an air-fuel ratio sensor, and an air-fuel ratio control device. The catalyst is disposed in an exhaust passage of the internal combustion engine, and configured to be able to occlude oxygen. The air-fuel ratio sensor is configured to detect an air-fuel ratio of an out-flow exhaust gas that flows out of the catalyst. The air-fuel ratio control device is configured to detect an air-fuel ratio of an in-flow exhaust gas that flows into the catalyst. The air-fuel ratio control device is configured to start slightly rich control in which the air-fuel ratio of the in-flow exhaust gas is controlled such that the air-fuel ratio of the out-flow exhaust gas detected by the air-fuel ratio sensor is maintained at a slightly rich setting air-fuel ratio that is richer than a stoichiometric air-fuel ratio, when the air-fuel ratio of the out-flow exhaust gas detected by the air-fuel ratio sensor is reduced to be equal to or less than a rich-side switching air-fuel ratio that is richer than the stoichiometric air-fuel ratio.

In the exhaust gas control apparatus according to the first aspect described above, the air-fuel ratio control device may be configured to start the slightly rich control when the air-fuel ratio of the out-flow exhaust gas detected by the air-fuel ratio sensor is reduced to be equal to or less than the rich-side switching air-fuel ratio while the air-fuel ratio of the in-flow exhaust gas is controlled such that the air-fuel ratio of the out-flow exhaust gas detected by the air-fuel ratio sensor is maintained at the stoichiometric air-fuel ratio or more.

In the exhaust gas control apparatus according to the first aspect described above, the air-fuel ratio control device may be configured to execute stoichiometric air-fuel ratio control in which the air-fuel ratio of the in-flow exhaust gas is controlled such that the air-fuel ratio of the out-flow exhaust gas detected by the air-fuel ratio sensor is maintained at the stoichiometric air-fuel ratio. The air-fuel ratio control device may be configured to start the slightly rich control when the air-fuel ratio of the out-flow exhaust gas detected by the air-fuel ratio sensor is reduced to be equal to or less than the rich-side switching air-fuel ratio in the stoichiometric air-fuel ratio control.

In the exhaust gas control apparatus according to the first aspect described above, the air-fuel ratio control device may be configured to end the slightly rich control when the air-fuel ratio of the out-flow exhaust gas detected by the air-fuel ratio sensor is increased to be equal to or more than a lean-side switching air-fuel ratio that is equal to or more than the stoichiometric air-fuel ratio in the slightly rich control.

In the exhaust gas control apparatus configured as described above, the air-fuel ratio control device may be configured to start stoichiometric air-fuel ratio control in which the air-fuel ratio of the in-flow exhaust gas is controlled such that the air-fuel ratio of the out-flow exhaust gas detected by the air-fuel ratio sensor is maintained at the stoichiometric air-fuel ratio when the air-fuel ratio of the out-flow exhaust gas detected by the air-fuel ratio sensor in the slightly rich control is increased to be equal to or more than the lean-side switching air-fuel ratio.

In the exhaust gas control apparatus according to the first aspect described above, the air-fuel ratio control device may be configured to determine a degree of richness of the slightly rich setting air-fuel ratio based on a minimum air-fuel ratio at a time when the air-fuel ratio of the out-flow exhaust gas detected by the air-fuel ratio sensor is reduced to be equal to or less than the rich-side switching air-fuel ratio.

In the exhaust gas control apparatus according to the first aspect described above, the air-fuel ratio control device may be configured to estimate a concentration of hydrogen in the out-flow exhaust gas, and determine a degree of richness of the slightly rich setting air-fuel ratio based on the hydrogen concentration.

A second aspect of the present disclosure relates to an exhaust gas control method for an internal combustion engine including a catalyst, an air-fuel ratio sensor, and an air-fuel ratio control device. The catalyst is disposed in an exhaust passage of the internal combustion engine, and configured to be able to occlude oxygen. The air-fuel ratio sensor is configured to detect an air-fuel ratio of an out-flow exhaust gas that flows out of the catalyst. The air-fuel ratio control device is configured to control an air-fuel ratio of an in-flow exhaust gas that flows into the catalyst. The exhaust gas control method includes starting slightly rich control in which the air-fuel ratio of the in-flow exhaust gas is controlled such that the air-fuel ratio of the out-flow exhaust gas detected by the air-fuel ratio sensor is maintained at a slightly rich setting air-fuel ratio that is richer than a stoichiometric air-fuel ratio, when the air-fuel ratio of the out-flow exhaust gas detected by the air-fuel ratio sensor is reduced to be equal to or less than a rich-side switching air-fuel ratio that is richer than the stoichiometric air-fuel ratio.

With the exhaust gas control apparatus and the exhaust gas control method for an internal combustion engine according to the present disclosure, it is possible to suppress degradation in exhaust emission by performing air-fuel ratio control in accordance with the situation of generation of hydrogen in a catalyst when the air-fuel ratio of an exhaust gas is controlled based on an output from an air-fuel ratio sensor disposed downstream of the catalyst.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an internal combustion engine with an exhaust gas control apparatus for an internal combustion engine according to a first embodiment of the present disclosure;

FIG. 2 illustrates an example of the control properties of a catalyst (three-way catalyst) illustrated in FIG. 1;

FIG. 3 is a partial sectional view of a downstream air-fuel ratio sensor illustrated in FIG. 1;

FIG. 4 illustrates the relationship between the air-fuel ratio of an exhaust gas and an output current from a sensor element in the downstream air-fuel ratio sensor;

FIG. 5A is a time chart of various parameters at the time when the air-fuel ratio of an exhaust gas that flows into the catalyst is switched between an air-fuel ratio that is richer than the stoichiometric air-fuel ratio and an air-fuel ratio that is leaner than the stoichiometric air-fuel ratio;

FIG. 5B schematically illustrates the state of oxygen occluded in the catalyst at each time in FIG. 5A;

FIG. 6 is a time chart of various parameters at the time when air-fuel ratio control according to the first embodiment of the present disclosure is executed;

FIG. 7A is a flowchart illustrating a control routine of the air-fuel ratio control according to the first embodiment;

FIG. 7B is a flowchart illustrating the control routine of the air-fuel ratio control according to the first embodiment;

FIG. 7C is a flowchart illustrating the control routine of the air-fuel ratio control according to the first embodiment;

FIG. 8 illustrates a minimum air-fuel ratio at the time when an output air-fuel ratio of the downstream air-fuel ratio sensor is reduced to be equal to or less than a rich-side switching air-fuel ratio in the internal combustion engine;

FIG. 9 is a flowchart illustrating a control routine of air-fuel ratio control according to a second embodiment of the present disclosure;

FIG. 10 illustrates an example of a map for determining a slightly rich setting air-fuel ratio and the values of a first upper determination air-fuel ratio and a first lower determination air-fuel ratio based on a minimum air-fuel ratio in the second embodiment;

FIG. 11 schematically illustrates a part of an internal combustion engine with an exhaust gas control apparatus for an internal combustion engine according to a third embodiment of the present disclosure; and

FIG. 12 is a flowchart illustrating a control routine of air-fuel ratio control according to the third embodiment.

### DETAILED DESCRIPTION OF EMBODIMENTS

Embodiments of the present disclosure will be described in detail below with reference to the drawings. In the following description, like constituent elements are denoted by like reference signs.

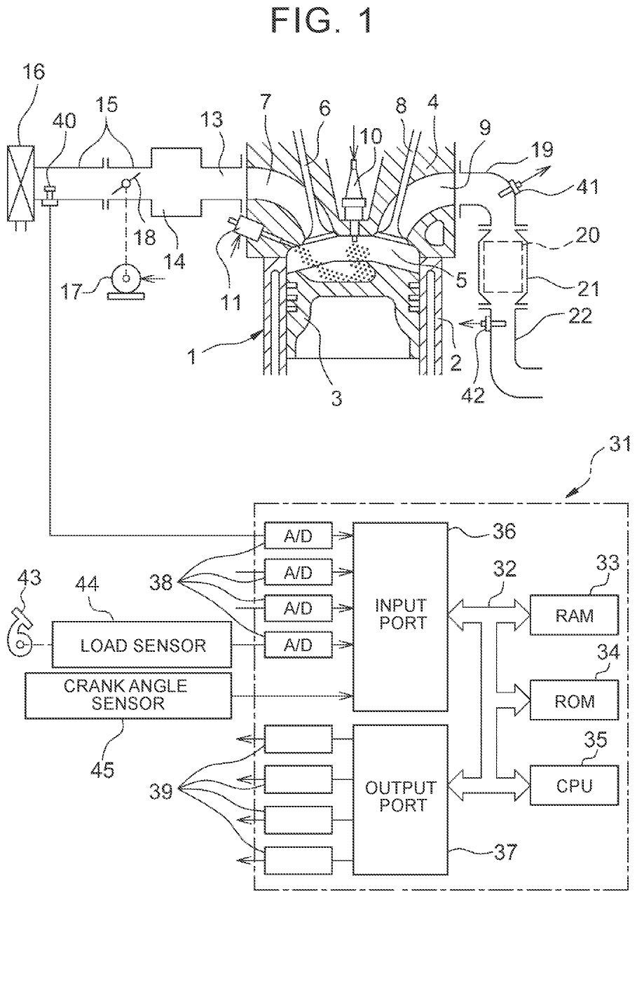

First, a first embodiment of the present disclosure will be described with reference to FIGS. 1 to 7C.

First, the entire internal combustion engine is described. FIG. 1 schematically illustrates an internal combustion engine with an exhaust gas control apparatus for an internal combustion engine according to the first embodiment of the present disclosure. The internal combustion engine illustrated in FIG. 1 is a spark-ignition internal combustion engine. The internal combustion engine is mounted on a vehicle, and used as a power source for the vehicle.

The internal combustion engine includes an engine body 1 that includes a cylinder block 2 and a cylinder head 4. A plurality of (e.g. four) cylinders is formed inside the cylinder block 2. A piston 3 is disposed in each cylinder to reciprocate in the direction of the axis of the cylinder. A combustion chamber 5 is formed between the piston 3 and the cylinder head 4.

An intake port 7 and an exhaust port 9 are formed in the cylinder head 4. The intake port 7 and the exhaust port 9 are connected to the combustion chamber 5.

The internal combustion engine also includes an intake valve 6 and an exhaust valve 8 disposed in the cylinder head 4. The intake valve 6 opens and closes the intake port 7. The exhaust valve 8 opens and closes the exhaust port 9.

The internal combustion engine includes a spark plug 10 and a fuel injection valve 11. The spark plug 10 is disposed at the central portion of the inner wall surface of the cylinder head 4, and generates a spark in accordance with an ignition signal. The fuel injection valve 11 is disposed at the peripheral portion of the inner wall surface of the cylinder head 4, and injects fuel into the combustion chamber 5 in accordance with an injection signal. In the present embodiment, gasoline with a stoichiometric air-fuel ratio of 14.6 is used as fuel to be supplied to the fuel injection valve 11.

The internal combustion engine also includes an intake manifold 13, a surge tank 14, an intake pipe 15, an air cleaner 16, and a throttle valve 18. The intake port 7 of each cylinder is coupled to the surge tank 14 via the corresponding intake manifold 13. The surge tank 14 is coupled to the air cleaner 16 via the intake pipe 15. The intake port 7, the intake manifold 13, the surge tank 14, the intake pipe 15, etc. form an intake passage that leads air to the combustion chamber 5. The throttle valve 18 is disposed in the intake pipe 15 between the surge tank 14 and the air cleaner 16, and driven by a throttle valve drive actuator 17 (e.g. a direct current (DC) motor). The throttle valve 18 is turned by the throttle valve drive actuator 17 to be able to change the area of opening of the intake passage in accordance with the degree of opening of the throttle valve 18.

The internal combustion engine also includes an exhaust manifold 19, a catalyst 20, a casing 21, and an exhaust pipe 22. The exhaust port 9 of each cylinder is coupled to the exhaust manifold 19. The exhaust manifold 19 has a plurality of branched portions coupled to the respective exhaust ports 9 and a merged portion at which the branched portions are merged. The merged portion of the exhaust manifold 19 is coupled to the casing 21 in which the catalyst 20 is provided. The casing 21 is coupled to the exhaust pipe 22. The exhaust port 9, the exhaust manifold 19, the casing 21, the exhaust pipe 22, etc. form an exhaust passage that discharges an exhaust gas generated through combustion of an air-fuel mixture in the combustion chamber 5.

The vehicle on which the internal combustion engine is mounted is provided with an electronic control unit (ECU) 31. As illustrated in FIG. 1, the ECU 31 is composed of a digital computer, and includes a random-access memory (RAM) 33, a read only memory (ROM) 34, a central processing unit (CPU; microprocessor) 35, an input port 36, and an output port 37, which are connected to each other via a bidirectional bus 32. While one ECU 31 is provided in the present embodiment, a plurality of ECUs may be provided for each function.

The ECU 31 executes various types of control of the internal combustion engine based on outputs etc. from various sensors provided in the vehicle or the internal combustion engine. Therefore, the outputs from the various sensors are transmitted to the ECU 31. In the present embodiment, outputs from an air flow meter 40, an upstream air-fuel ratio sensor 41, a downstream air-fuel ratio sensor 42, a load sensor 44, and a crank angle sensor 45 are transmitted to the ECU 31.

The air flow meter 40 is disposed in the intake passage of the internal combustion engine, specifically in the intake pipe 15 upstream of the throttle valve 18. The air flow meter 40 detects the flow rate of air that flows through the intake passage. The air flow meter 40 is electrically connected to the ECU 31. An output from the air flow meter 40 is input to the input port 36 via a corresponding analog-digital (AD) converter 38.

The upstream air-fuel ratio sensor 41 is disposed in the exhaust passage upstream of the catalyst 20, specifically at the merged portion of the exhaust manifold 19. The upstream air-fuel ratio sensor 41 detects the air-fuel ratio of an exhaust gas that flows in the exhaust manifold 19, that is, an exhaust gas discharged from the cylinders of the internal combustion engine and flowing into the catalyst 20. The upstream air-fuel ratio sensor 41 is electrically connected to the ECU 31. An output from the upstream air-fuel ratio sensor 41 is input to the input port 36 via a corresponding AD converter 38.

The downstream air-fuel ratio sensor 42 is disposed in the exhaust passage downstream of the catalyst 20, specifically in the exhaust pipe 22. The downstream air-fuel ratio sensor 42 detects the air-fuel ratio of an exhaust gas that flows in the exhaust pipe 22, that is, an exhaust gas that flows out of the catalyst 20. The downstream air-fuel ratio sensor 42 is electrically connected to the ECU 31. An output from the downstream air-fuel ratio sensor 42 is input to the input port 36 via a corresponding AD converter 38.

The load sensor 44 is connected to an accelerator pedal 43 provided in the vehicle on which the internal combustion engine is mounted, and detects the amount of depression of the accelerator pedal 43. The load sensor 44 is electrically connected to the ECU 31. An output from the load sensor 44 is input to the input port 36 via a corresponding AD converter 38. The ECU 31 calculates an engine load based on the output from the load sensor 44.

The crank angle sensor 45 generates an output pulse each time a crankshaft of the internal combustion engine is rotated by a predetermined angle (e.g. 10 degrees). The crank angle sensor 45 is electrically connected to the ECU 31. An output from the crank angle sensor 45 is input to the input port 36. The ECU 31 calculates an engine rotational speed based on the output from the crank angle sensor 45.

On the other hand, the output port 37 of the ECU 31 is connected to the spark plug 10, the fuel injection valve 11, and the throttle valve drive actuator 17 via corresponding drive circuits 39, allowing the ECU 31 to control the spark plug 10, the fuel injection valve 11, and the throttle valve drive actuator 17. Specifically, the ECU 31 controls the ignition timing of the spark plug 10, the injection timing and the injection amount of fuel injected from the fuel injection valve 11, and the degree of opening of the throttle valve 18.

While the internal combustion engine discussed above is a non-supercharged internal combustion engine that uses gasoline as fuel, the configuration of the internal combustion engine is not limited to the above configuration. Thus, the specific configuration of the internal combustion engine, such as the cylinder arrangement, the manner of fuel injection, the configuration of the intake and exhaust systems, the configuration of the valve moving mechanism, the presence or absence of a supercharger, may be different from the configuration illustrated in FIG. 1. For example, the fuel injection valve 11 may be disposed so as to inject fuel into the intake port 7. The internal combustion engine may be provided with a component that allows an exhaust gas recirculation (EGR) gas to be recirculated from the exhaust passage to the intake passage.

An exhaust gas control apparatus for an internal combustion engine (hereinafter simply referred to as an “exhaust gas control apparatus”) according to the first embodiment of the present disclosure will be described below. The exhaust gas control apparatus includes the catalyst 20, the upstream air-fuel ratio sensor 41, the downstream air-fuel ratio sensor 42, and an air-fuel ratio control device. In the present embodiment, the ECU 31 functions as an air-fuel ratio control device.

The catalyst 20 is disposed in the exhaust passage of the internal combustion engine, and configured to control an exhaust gas that flows through the exhaust passage. In the present embodiment, the catalyst 20 is a three-way catalyst that can occlude oxygen and that can control hydrocarbon (HC), carbon monoxide (CO), and nitrogen oxide (NOx) at the same time, for example. The catalyst 20 includes a carrier (base material) composed of ceramic or metal, precious metal having a catalytic action (e.g. platinum (Pt), palladium (Pd), rhodium (Rh), etc.), and a promoter having an oxygen occlusion capability (e.g. ceria (CeO₂) etc.). The precious metal and the promotor are carried by the carrier.

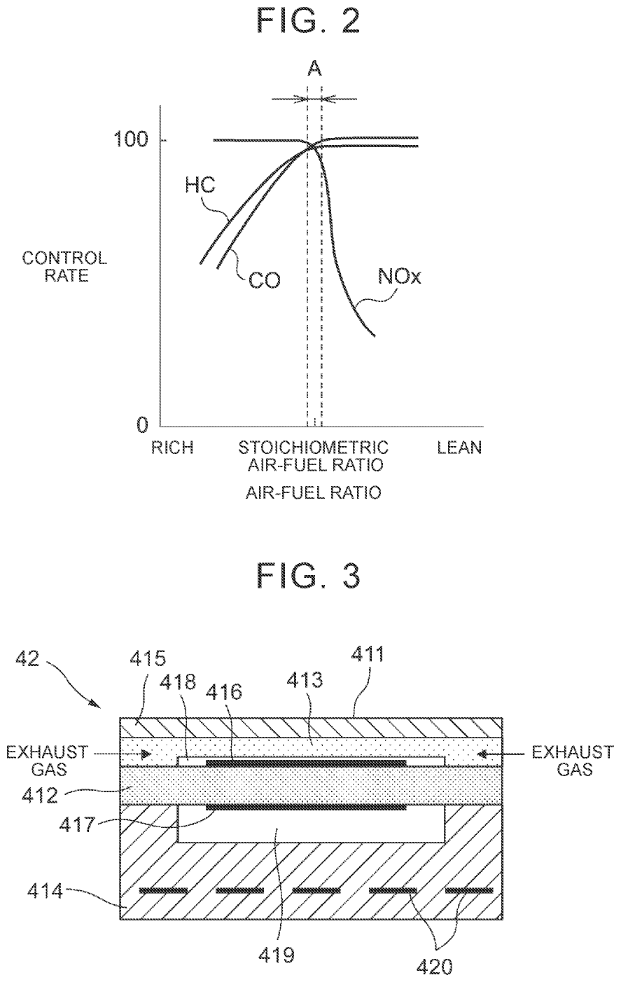

FIG. 2 illustrates an example of the control properties of the three-way catalyst. As indicated in FIG. 2, the rate of control of HC, CO, and NOx by the three-way catalyst is significantly high when the air-fuel ratio of an exhaust gas that flows into the three-way catalyst is in a region in the vicinity of the stoichiometric air-fuel ratio (control window A in FIG. 2). Thus, the catalyst 20 can effectively control HC, CO, and NOx when the air-fuel ratio of the exhaust gas is maintained in the vicinity of the stoichiometric air-fuel ratio.

The catalyst 20 occludes and releases oxygen in accordance with the air-fuel ratio of the exhaust gas using the promoter. Specifically, the catalyst 20 occludes excessive oxygen in the exhaust gas when the air-fuel ratio of the exhaust gas is leaner than the stoichiometric air-fuel ratio. On the other hand, the catalyst 20 releases oxygen that is short for oxidizing HC and CO when the air-fuel ratio of the exhaust gas is richer than the stoichiometric air-fuel ratio. As a result, the air-fuel ratio on the surface of the catalyst 20 is maintained in the vicinity of the stoichiometric air-fuel ratio even when the air-fuel ratio of the exhaust gas slightly deviates from the stoichiometric air-fuel ratio, and HC, CO, and NOx are effectively controlled in the catalyst 20.

The upstream air-fuel ratio sensor 41 and the downstream air-fuel ratio sensor 42 are disposed in the exhaust passage of the internal combustion engine. The downstream air-fuel ratio sensor 42 is disposed downstream of the upstream air-fuel ratio sensor 41. The upstream air-fuel ratio sensor 41 and the downstream air-fuel ratio sensor 42 are each configured to detect the air-fuel ratio of the exhaust gas that flows through the exhaust passage.

FIG. 3 is a partial sectional view of the downstream air-fuel ratio sensor 42. The configuration of the downstream air-fuel ratio sensor 42, which has a known configuration, will be briefly described below. The upstream air-fuel ratio sensor 41 has the same configuration as that of the downstream air-fuel ratio sensor 42.

The downstream air-fuel ratio sensor 42 includes a sensor element 411 and heaters 420. In the present embodiment, the downstream air-fuel ratio sensor 42 is a stacked air-fuel ratio sensor constituted by stacking a plurality of layers. As illustrated in FIG. 3, the sensor element 411 has a solid electrolyte layer 412, a diffusion limitation layer 413, a first impermeable layer 414, a second impermeable layer 415, an exhaust-side electrode 416, and an atmosphere-side electrode 417. A measured gas chamber 418 is formed between the solid electrolyte layer 412 and the diffusion limitation layer 413. An atmosphere chamber 419 is formed between the solid electrolyte layer 412 and the first impermeable layer 414.

The exhaust gas is introduced into the measured gas chamber 418 via the diffusion limitation layer 413 as a gas to be measured. The atmosphere is introduced into the atmosphere chamber 419. When a voltage is applied to the sensor element 411, oxide ions are moved between the exhaust-side electrode 416 and the atmosphere-side electrode 417 in accordance with the air-fuel ratio of the exhaust gas on the exhaust-side electrode 416, as a result of which the output current from the sensor element 411 is varied in accordance with the air-fuel ratio of the exhaust gas.

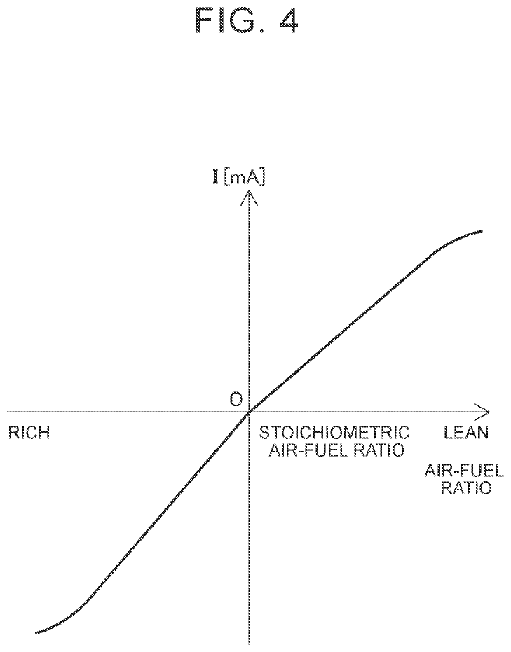

FIG. 4 illustrates the relationship between the air-fuel ratio of the exhaust gas and the output current I from the sensor element 411 in the downstream air-fuel ratio sensor 42. In the example in FIG. 4, a voltage of 0.45 V is applied to the sensor element 411. As can be seen from FIG. 4, an output current I is zero when the air-fuel ratio of the exhaust gas is the stoichiometric air-fuel ratio. In the downstream air-fuel ratio sensor 42, the output current I becomes larger as the concentration of oxygen in the exhaust gas becomes higher, that is, as the air-fuel ratio of the exhaust gas becomes leaner. Thus, the downstream air-fuel ratio sensor 42 and the upstream air-fuel ratio sensor 41, which has the same configuration as that of the downstream air-fuel ratio sensor 42, can continuously (linearly) detect the air-fuel ratio of the exhaust gas.

In the present embodiment, air-fuel ratio sensors of a limiting current type are used as the upstream air-fuel ratio sensor 41 and the downstream air-fuel ratio sensor 42. However, air-fuel ratio sensors that are not of a limiting current type may be used as the upstream air-fuel ratio sensor 41 and the downstream air-fuel ratio sensor 42 as long as an output current from such air-fuel ratio sensors is varied linearly with respect to the air-fuel ratio of the exhaust gas. The upstream air-fuel ratio sensor 41 and the downstream air-fuel ratio sensor 42 may be air-fuel ratio sensors of different structures.

The air-fuel ratio control device controls the air-fuel ratio of an exhaust gas that flows into the catalyst 20 (hereinafter referred to as an “in-flow exhaust gas”). In the present embodiment, the air-fuel ratio control device controls the air-fuel ratio of the in-flow exhaust gas based on an output from the upstream air-fuel ratio sensor 41 and an output from the downstream air-fuel ratio sensor 42. Specifically, the air-fuel ratio control device sets a target air-fuel ratio for the in-flow exhaust gas based on the output from the downstream air-fuel ratio sensor 42, and performs feedback control of the amount of fuel supplied to the combustion chamber 5 such that the output air-fuel ratio of the upstream air-fuel ratio sensor 41 coincides with the target air-fuel ratio. The “output air-fuel ratio” means an air-fuel ratio corresponding to an output value from an air-fuel ratio sensor, that is, an air-fuel ratio detected by an air-fuel ratio sensor.

The air-fuel ratio control device may control the amount of fuel supplied to the combustion chamber 5 such that the air-fuel ratio of the in-flow exhaust gas coincides with the target air-fuel ratio without using the upstream air-fuel ratio sensor 41. In this case, the upstream air-fuel ratio sensor 41 is omitted from the exhaust gas control apparatus, and the air-fuel ratio control device calculates the amount of fuel supplied to the combustion chamber 5 from the intake air amount, the engine rotational speed, and the target air-fuel ratio such that the ratio of fuel and air supplied to the combustion chamber 5 coincides with the target air-fuel ratio.

In the present embodiment, the air-fuel ratio of the in-flow exhaust gas is basically controlled such that the catalyst 20 is maintained in the state of being suitable for exhaust gas control. When the catalyst 20 is in the state of being suitable for exhaust gas control, the exhaust gas is controlled in the catalyst 20, and the air-fuel ratio of an exhaust gas that flows out of the catalyst 20 (hereinafter referred to as an “out-flow exhaust gas”) is brought to the stoichiometric air-fuel ratio. Therefore, it is conceivable to control the air-fuel ratio of the in-flow exhaust gas such that the output air-fuel ratio of the downstream air-fuel ratio sensor 42 disposed downstream of the catalyst 20 is brought to the stoichiometric air-fuel ratio.

When oxygen is depleted in the catalyst 20, however, the following water gas shift reaction (1) and steam reforming reaction (2) are caused to generate hydrogen in the catalyst 20.

CO+H₂O→H₂+CO₂ (1)

HC+H₂O→CO+H₂ (2)

As a result, an exhaust gas containing hydrogen flows out of the catalyst 20, and flows into the downstream air-fuel ratio sensor 42. At this time, the molecular weight of hydrogen is less than the molecular weight of oxygen, and therefore hydrogen in the exhaust gas passes through the diffusion limitation layer 413 and reaches the exhaust-side electrode 416 faster than oxygen in the exhaust gas. Therefore, the concentration of oxygen in the exhaust gas on the exhaust-side electrode 416 becomes lower than the concentration of oxygen in the exhaust gas in the exhaust passage. As a result, a deviation is caused in the output from the downstream air-fuel ratio sensor 42, and the output from the downstream air-fuel ratio sensor 42 deviates to the rich side from the actual value. Thus, the reliability of the output from the downstream air-fuel ratio sensor 42 is reduced when hydrogen flows into the downstream air-fuel ratio sensor 42 from the catalyst 20.

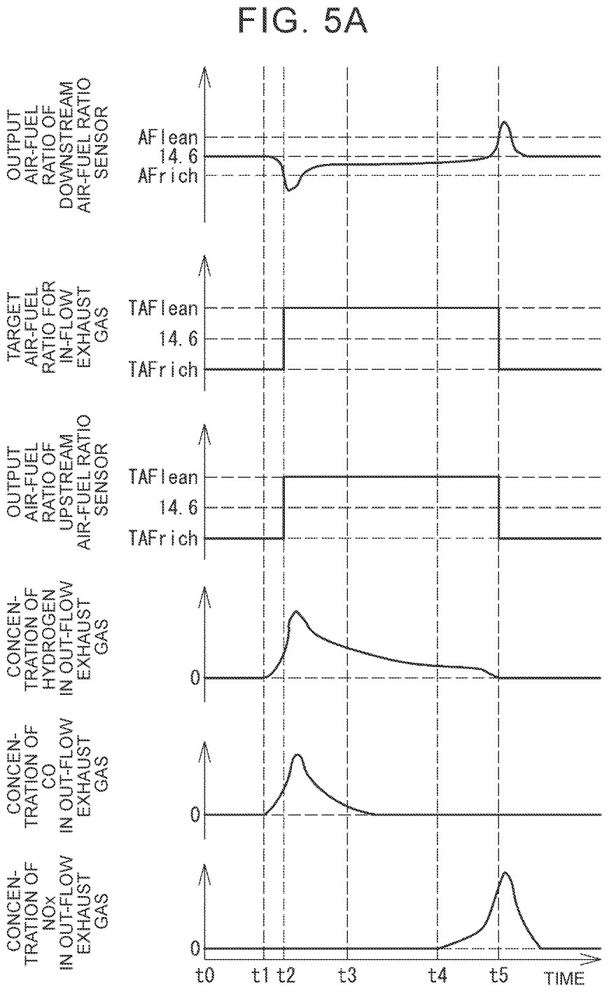

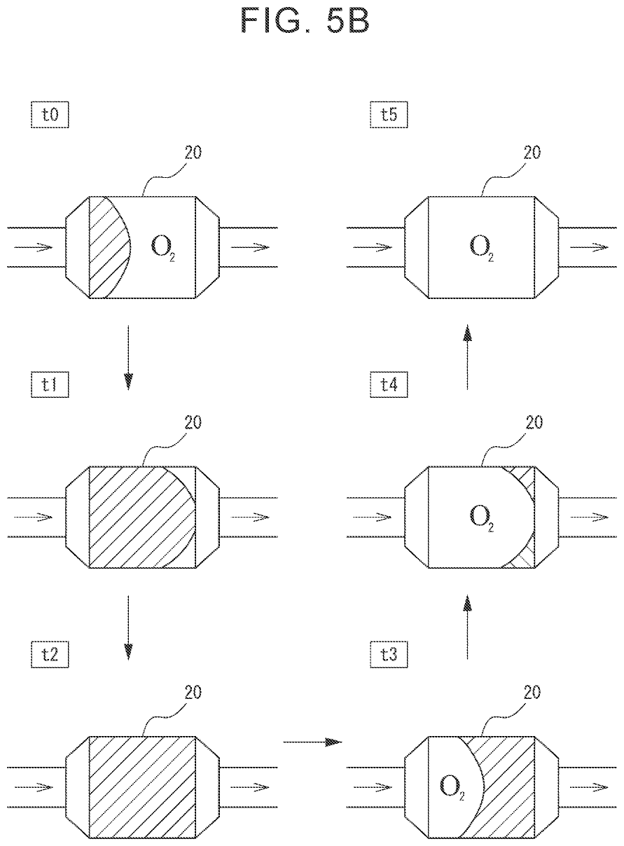

FIG. 5A is a time chart of various parameters at the time when the air-fuel ratio of the in-flow exhaust gas is switched between an air-fuel ratio that is richer than the stoichiometric air-fuel ratio and an air-fuel ratio that is leaner than the stoichiometric air-fuel ratio. FIG. 5A indicates, as the parameters, the output air-fuel ratio of the downstream air-fuel ratio sensor 42, the target air-fuel ratio for the in-flow exhaust gas, the output air-fuel ratio of the upstream air-fuel ratio sensor 41, the concentration of hydrogen in the out-flow exhaust gas, the concentration of CO in the out-flow exhaust gas, and the concentration of NOx in the out-flow exhaust gas.

FIG. 5B schematically illustrates the state of oxygen occluded in the catalyst 20 at each time (times t0 to t5) in FIG. 5A. FIG. 5B illustrates the state of oxygen occluded in the catalyst 20 together with the direction in which the exhaust gas flows through the catalyst 20. A hatched portion of the catalyst 20 indicates an oxygen depletion region in which oxygen has been depleted. The other portion of the catalyst 20 indicates a region filled with oxygen.

In this example, at time t0, the target air-fuel ratio for the in-flow exhaust gas is set to a rich setting air-fuel ratio TAFrich that is richer than the stoichiometric air-fuel ratio. When an exhaust gas at a rich air-fuel ratio flows into the catalyst 20 filled with oxygen, the oxygen is gradually released from the upstream side of the catalyst 20. As a result, at time t0, as illustrated in FIG. 5B, an oxygen depletion region is formed on the upstream side of the catalyst 20. In this case, hydrogen generated in the oxygen depletion region is oxidized on the downstream side of the catalyst 20, and therefore almost no hydrogen flows out of the catalyst 20. CO and NOx in the exhaust gas are effectively controlled in the catalyst 20, and therefore the output air-fuel ratio of the downstream air-fuel ratio sensor 42 is maintained at the stoichiometric air-fuel ratio.

After that, at time t1, most of the region of the catalyst 20 is brought into the oxygen depletion region, hydrogen and CO flow out of the catalyst 20, and the output air-fuel ratio of the downstream air-fuel ratio sensor 42 starts being varied to the rich side. In the example in FIG. 5A, when the output air-fuel ratio of the downstream air-fuel ratio sensor 42 reaches a rich determination air-fuel ratio AFrich at time t2, the target air-fuel ratio for the in-flow exhaust gas is switched from the rich setting air-fuel ratio TAFrich to a lean setting air-fuel ratio TAFlean that is leaner than the stoichiometric air-fuel ratio. At time t2, as illustrated in FIG. 5B, all the region of the catalyst 20 has been brought into the oxygen depletion region.

When an exhaust gas with a lean air-fuel ratio flows into the catalyst 20 in which oxygen has been depleted, the catalyst 20 is gradually filled with oxygen from the upstream side of the catalyst 20. As a result, at time t3, as illustrated in FIG. 5B, the upstream side of the catalyst 20 is filled with oxygen and the oxygen depletion region remains on the downstream side of the catalyst 20. In this case, CO and NOx in the exhaust gas are effectively controlled in the catalyst 20. However, hydrogen generated in the oxygen depletion region on the downstream side of the catalyst 20 flows into the downstream air-fuel ratio sensor 42 from the catalyst 20, and therefore the output air-fuel ratio of the downstream air-fuel ratio sensor 42 indicates a value that is richer than the stoichiometric air-fuel ratio.

After that, at time t4, most of the region of the catalyst 20 is filled with oxygen, and NOx starts flowing out of the catalyst 20. Also at this time, hydrogen generated in the oxygen depletion region that slightly remains on the downstream side of the catalyst 20 flows out of the catalyst 20, and the output from the downstream air-fuel ratio sensor 42 is affected by the hydrogen. In the example in FIG. 5A, when the output air-fuel ratio of the downstream air-fuel ratio sensor 42 reaches the lean determination air-fuel ratio AFlean at time t5, the target air-fuel ratio for the in-flow exhaust gas is switched from the lean setting air-fuel ratio TAFlean to the rich setting air-fuel ratio TAFrich. At time t5, as illustrated in FIG. 5B, all the region of the catalyst 20 is filled with oxygen. Therefore, an outflow of hydrogen from the catalyst 20 is ended at time t5.

As can be seen from FIG. 5A, when hydrogen is flowing out of the catalyst 20, the catalyst 20 is in the state of being suitable for exhaust gas control when the output air-fuel ratio of the downstream air-fuel ratio sensor 42 is richer than the stoichiometric air-fuel ratio. Therefore, when the air-fuel ratio of the in-flow exhaust gas is controlled such that the output air-fuel ratio of the downstream air-fuel ratio sensor 42 is brought to the stoichiometric air-fuel ratio irrespective of the situation of generation of hydrogen in the catalyst 20, the amount of NOx that flows out of the catalyst 20 is increased, which may degrade exhaust emission.

When no hydrogen is flowing out of the catalyst 20, on the other hand, the catalyst 20 is in the state of being suitable for exhaust gas control when the output air-fuel ratio of the downstream air-fuel ratio sensor 42 is the stoichiometric air-fuel ratio. Therefore, if air-fuel ratio control is always executed in consideration of the effect of hydrogen, exhaust emission may be degraded when the state of the catalyst 20 is varied in accordance with the operation state of the internal combustion engine.

Thus, in the present embodiment, when the output air-fuel ratio of the downstream air-fuel ratio sensor 42 is reduced to be equal to or less than a rich-side switching air-fuel ratio that is richer than the stoichiometric air-fuel ratio, the air-fuel ratio control device starts slightly rich control in which the air-fuel ratio of the in-flow exhaust gas is controlled such that the output air-fuel ratio of the downstream air-fuel ratio sensor 42 is maintained at a slightly rich setting air-fuel ratio that is richer than the stoichiometric air-fuel ratio. Consequently, air-fuel ratio control can be performed in consideration of the effect of hydrogen when it is highly likely that hydrogen is flowing out of the catalyst 20. That is, with the present embodiment, it is possible to suppress degradation in exhaust emission by performing air-fuel ratio control in accordance with the situation of generation of hydrogen in the catalyst 20.

In the slightly rich control, the air-fuel ratio control device controls the air-fuel ratio of the in-flow exhaust gas such that the output air-fuel ratio of the downstream air-fuel ratio sensor 42 is varied within a predetermined range centered on the slightly rich setting air-fuel ratio, in order to maintain the output air-fuel ratio of the downstream air-fuel ratio sensor 42 at the slightly rich setting air-fuel ratio. For example, in the slightly rich control, the air-fuel ratio control device sets the target air-fuel ratio for the in-flow exhaust gas to a rich setting air-fuel ratio that is richer than the stoichiometric air-fuel ratio when the output air-fuel ratio of the downstream air-fuel ratio sensor 42 is increased to be equal to or more than a first upper determination air-fuel ratio, and sets the target air-fuel ratio for the in-flow exhaust gas to a lean setting air-fuel ratio that is leaner than the stoichiometric air-fuel ratio when the output air-fuel ratio of the downstream air-fuel ratio sensor 42 is reduced to be equal to or less than a first lower determination air-fuel ratio. The first upper determination air-fuel ratio and the first lower determination air-fuel ratio are determined in advance such that the difference between the first upper determination air-fuel ratio and the slightly rich setting air-fuel ratio is equal to the difference between the first lower determination air-fuel ratio and the slightly rich setting air-fuel ratio and the first upper determination air-fuel ratio is higher (leaner) than the first lower determination air-fuel ratio.

In the present embodiment, in particular, the air-fuel ratio control device starts the slightly rich control when the output air-fuel ratio of the downstream air-fuel ratio sensor 42 is reduced to be equal to or less than the rich-side switching air-fuel ratio while the air-fuel ratio of the in-flow exhaust gas is controlled such that the output air-fuel ratio of the downstream air-fuel ratio sensor 42 is maintained at the stoichiometric air-fuel ratio or more, e.g. while the air-fuel ratio of the in-flow exhaust gas is controlled to a value that is equal to or more than the stoichiometric air-fuel ratio. Consequently, it is possible to suppress degradation in exhaust emission when hydrogen unintentionally flows out of the catalyst 20.

When the catalyst 20 is filled with oxygen because of the effect of disturbance etc. during the slightly rich control, an outflow of hydrogen from the catalyst 20 is ended. Therefore, in the present embodiment, the air-fuel ratio control device ends the slightly rich control when the output air-fuel ratio of the downstream air-fuel ratio sensor 42 is increased to be equal to or more than a lean-side switching air-fuel ratio that is equal to or more than the stoichiometric air-fuel ratio in the slightly rich control. Consequently, the slightly rich control can be ended at an appropriate timing when the outflow of hydrogen from the catalyst 20 is ended.

When the outflow of hydrogen from the catalyst 20 is ended, a deviation in the output from the downstream air-fuel ratio sensor 42 is resolved. Therefore, when the output air-fuel ratio of the downstream air-fuel ratio sensor 42 is increased to be equal to or more than the lean-side switching air-fuel ratio, the air-fuel ratio control device starts stoichiometric air-fuel ratio control in which the air-fuel ratio of the in-flow exhaust gas is controlled such that the output air-fuel ratio of the downstream air-fuel ratio sensor 42 is maintained at the stoichiometric air-fuel ratio. Consequently, it is possible to effectively suppress degradation in exhaust emission when hydrogen is not flowing out of the catalyst 20.

In the stoichiometric air-fuel ratio control, the air-fuel ratio control device controls the air-fuel ratio of the in-flow exhaust gas such that the output air-fuel ratio of the downstream air-fuel ratio sensor 42 is varied within a predetermined range centered on the stoichiometric air-fuel ratio, in order to maintain the output air-fuel ratio of the downstream air-fuel ratio sensor 42 at the stoichiometric air-fuel ratio. For example, in the stoichiometric air-fuel ratio control, the air-fuel ratio control device sets the target air-fuel ratio for the in-flow exhaust gas to a rich setting air-fuel ratio that is richer than the stoichiometric air-fuel ratio when the output air-fuel ratio of the downstream air-fuel ratio sensor 42 is increased to be equal to or more than a second upper determination air-fuel ratio, and sets the target air-fuel ratio for the in-flow exhaust gas to a lean setting air-fuel ratio that is leaner than the stoichiometric air-fuel ratio when the output air-fuel ratio of the downstream air-fuel ratio sensor 42 is reduced to be equal to or less than a second lower determination air-fuel ratio. The second upper determination air-fuel ratio and the second lower determination air-fuel ratio are determined in advance such that the difference between the second upper determination air-fuel ratio and the stoichiometric air-fuel ratio is equal to the difference between the second lower determination air-fuel ratio and the stoichiometric air-fuel ratio and the second upper determination air-fuel ratio is higher (leaner) than the second lower determination air-fuel ratio.

Thus, in the present embodiment, the air-fuel ratio control device executes the slightly rich control since the output air-fuel ratio of the downstream air-fuel ratio sensor 42 is reduced to be equal to or less than the rich-side switching air-fuel ratio until the output air-fuel ratio of the downstream air-fuel ratio sensor 42 is increased to be equal to or more than the lean-side switching air-fuel ratio. Meanwhile, the air-fuel ratio control device executes the stoichiometric air-fuel ratio control since the output air-fuel ratio of the downstream air-fuel ratio sensor 42 is increased to be equal to or more than the lean-side switching air-fuel ratio until the output air-fuel ratio of the downstream air-fuel ratio sensor 42 is reduced to be equal to or less than the rich-side switching air-fuel ratio. That is, the air-fuel ratio control device starts the slightly rich control when the output air-fuel ratio of the downstream air-fuel ratio sensor 42 is reduced to be equal to or less than the rich-side switching air-fuel ratio in the stoichiometric air-fuel ratio control, and starts the stoichiometric air-fuel ratio control when the output air-fuel ratio of the downstream air-fuel ratio sensor 42 is increased to be equal to or more than the lean-side switching air-fuel ratio in the slightly rich control.

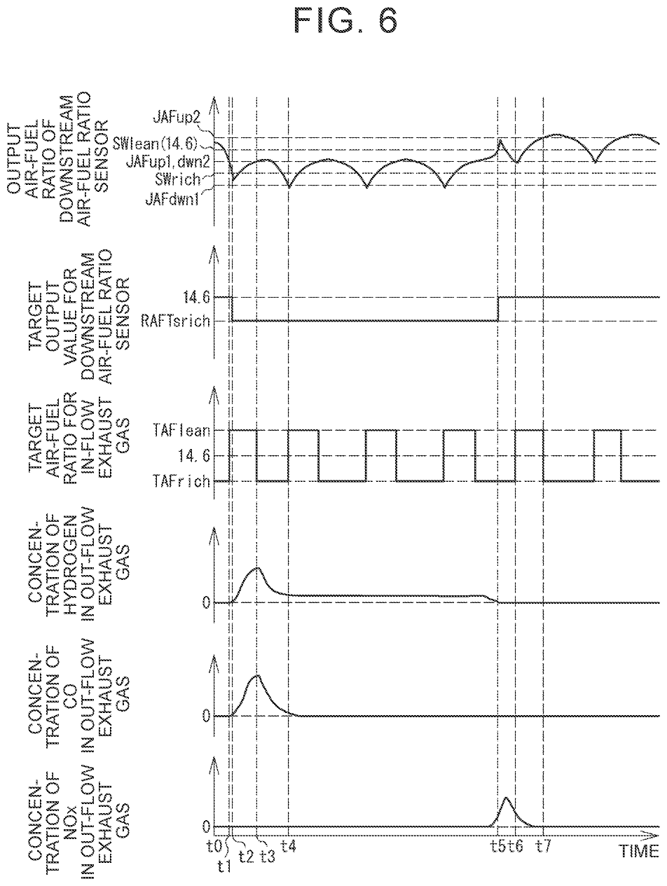

Next, the air-fuel ratio control will be described with reference to a time chart. The air-fuel ratio control discussed above is specifically described with reference to FIG. 6. FIG. 6 is a time chart of various parameters at the time when the air-fuel ratio control according to the first embodiment of the present disclosure is executed. FIG. 6 indicates, as the parameters, the output air-fuel ratio of the downstream air-fuel ratio sensor 42, the target output value for the downstream air-fuel ratio sensor 42, the target air-fuel ratio for the in-flow exhaust gas, the concentration of hydrogen in the out-flow exhaust gas, the concentration of CO in the out-flow exhaust gas, and the concentration of NOx in the out-flow exhaust gas.

In the example in FIG. 6, at time t0, the stoichiometric air-fuel ratio control is executed, and the target output value for the downstream air-fuel ratio sensor 42 is set to the stoichiometric air-fuel ratio (14.6). In the stoichiometric air-fuel ratio control, at time t0, the target air-fuel ratio for the in-flow exhaust gas is set to the rich setting air-fuel ratio TAFrich that is richer than the stoichiometric air-fuel ratio. Therefore, at and after time t0, the output air-fuel ratio of the downstream air-fuel ratio sensor 42 is gradually reduced. When the output air-fuel ratio of the downstream air-fuel ratio sensor 42 reaches a second lower determination air-fuel ratio JAFdwn2 at time t1, the target air-fuel ratio for the in-flow exhaust gas is set to the lean setting air-fuel ratio TAFlean that is leaner than the stoichiometric air-fuel ratio.

In the example in FIG. 6, at time t2, the output air-fuel ratio of the downstream air-fuel ratio sensor 42 has reached a rich-side switching air-fuel ratio SWrich because of the effect of disturbance etc. although the target air-fuel ratio for the in-flow exhaust gas is set to the lean setting air-fuel ratio TAFlean in the stoichiometric air-fuel ratio control. That is, in the stoichiometric air-fuel ratio control, the output air-fuel ratio of the downstream air-fuel ratio sensor 42 is reduced from a value that is equal to or more than the stoichiometric air-fuel ratio to the rich-side switching air-fuel ratio SWrich. Therefore, at time t2, the stoichiometric air-fuel ratio control is ended, and the slightly rich control is started. That is, the target output value for the downstream air-fuel ratio sensor 42 is switched from the stoichiometric air-fuel ratio to a slightly rich setting air-fuel ratio RAFTsrich that is richer than the stoichiometric air-fuel ratio.

When the output air-fuel ratio of the downstream air-fuel ratio sensor 42 is reduced toward the rich-side switching air-fuel ratio SWrich, oxygen in the catalyst 20 is depleted, and hydrogen and CO flow out of the catalyst 20. As a result, an exhaust gas containing hydrogen flows into the downstream air-fuel ratio sensor 42, and a deviation is caused in the output from the downstream air-fuel ratio sensor 42. However, by starting the slightly rich control at time t2, it is possible to bring the catalyst 20 into the state of being suitable for exhaust gas control, and to effectively suppress an outflow of CO and NOx at and after time t2.

After time t2, when the output air-fuel ratio of the downstream air-fuel ratio sensor 42 reaches a first upper determination air-fuel ratio JAFup1 at time t3, the target air-fuel ratio for the in-flow exhaust gas is switched from the lean setting air-fuel ratio TAFlean to the rich setting air-fuel ratio TAFrich in the slightly rich control. In the example in FIG. 6, the value of the first upper determination air-fuel ratio JAFup1 is equal to the value of the second lower determination air-fuel ratio JAFdwn2.

After time t3, when the output air-fuel ratio of the downstream air-fuel ratio sensor 42 reaches a first lower determination air-fuel ratio JAFdwn1 at time t4, the target air-fuel ratio for the in-flow exhaust gas is switched from the rich setting air-fuel ratio TAFrich to the lean setting air-fuel ratio TAFlean in the slightly rich control. Also after that, the target air-fuel ratio for the in-flow exhaust gas is switched in the same manner between the rich setting air-fuel ratio TAFrich and the lean setting air-fuel ratio TAFlean based on the output air-fuel ratio of the downstream air-fuel ratio sensor 42 in the slightly rich control.

In the example in FIG. 6, at time t5, the output air-fuel ratio of the downstream air-fuel ratio sensor 42 has reached a lean-side switching air-fuel ratio SWlean (14.6 in the example in FIG. 6) because of the effect of disturbance etc. although the target air-fuel ratio for the in-flow exhaust gas is set to the rich setting air-fuel ratio TAFrich in the slightly rich control. Therefore, at time t5, the slightly rich control is ended, and the stoichiometric air-fuel ratio control is started. That is, the target output value for the downstream air-fuel ratio sensor 42 is switched from the slightly rich setting air-fuel ratio RAFTsrich to the stoichiometric air-fuel ratio.

When the output air-fuel ratio of the downstream air-fuel ratio sensor 42 is increased toward the lean-side switching air-fuel ratio SWlean, the catalyst 20 is filled with oxygen, and NOx flows out of the catalyst 20. As a result, an outflow of hydrogen from the catalyst 20 is ended, and the deviation in the output from the downstream air-fuel ratio sensor 42 is resolved. However, by starting the stoichiometric air-fuel ratio control at time t5, it is possible to bring the catalyst 20 into the state of being suitable for exhaust gas control, and to effectively suppress an outflow of CO and NOx at and after time t5.

After time t5, when the output air-fuel ratio of the downstream air-fuel ratio sensor 42 reaches the second lower determination air-fuel ratio JAFdwn2 at time t6, the target air-fuel ratio for the in-flow exhaust gas is switched from the rich setting air-fuel ratio TAFrich to the lean setting air-fuel ratio TAFlean in the stoichiometric air-fuel ratio control. After time t6, when the output air-fuel ratio of the downstream air-fuel ratio sensor 42 reaches a second upper determination air-fuel ratio JAFup2 at time t7, the target air-fuel ratio for the in-flow exhaust gas is switched from the lean setting air-fuel ratio TAFlean to the rich setting air-fuel ratio TAFrich in the stoichiometric air-fuel ratio control. Also after that, the target air-fuel ratio for the in-flow exhaust gas is switched in the same manner between the rich setting air-fuel ratio TAFrich and the lean setting air-fuel ratio TAFlean based on the output air-fuel ratio of the downstream air-fuel ratio sensor 42 in the stoichiometric air-fuel ratio control.

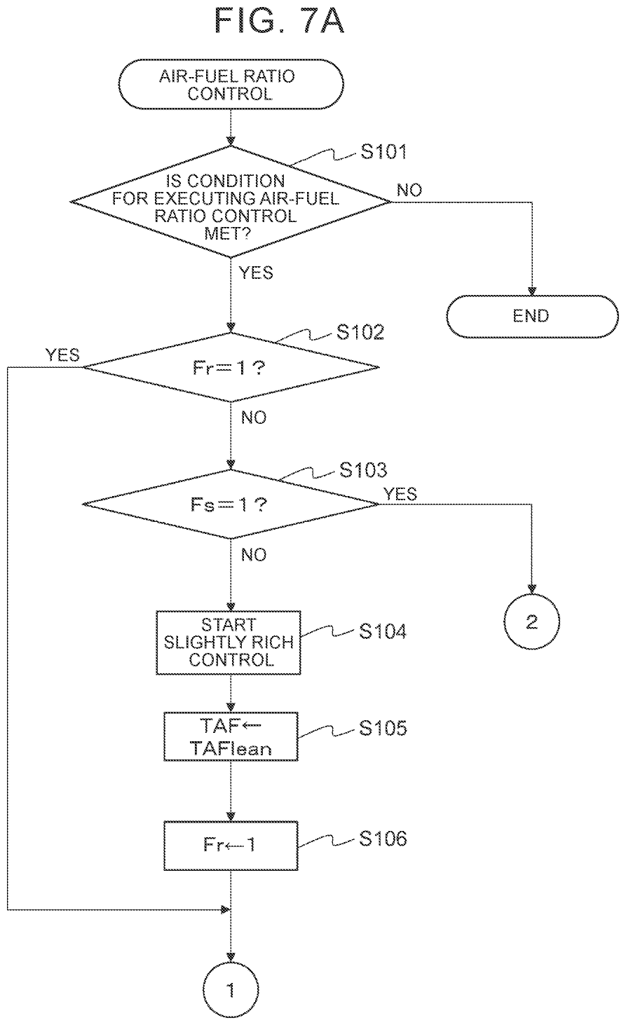

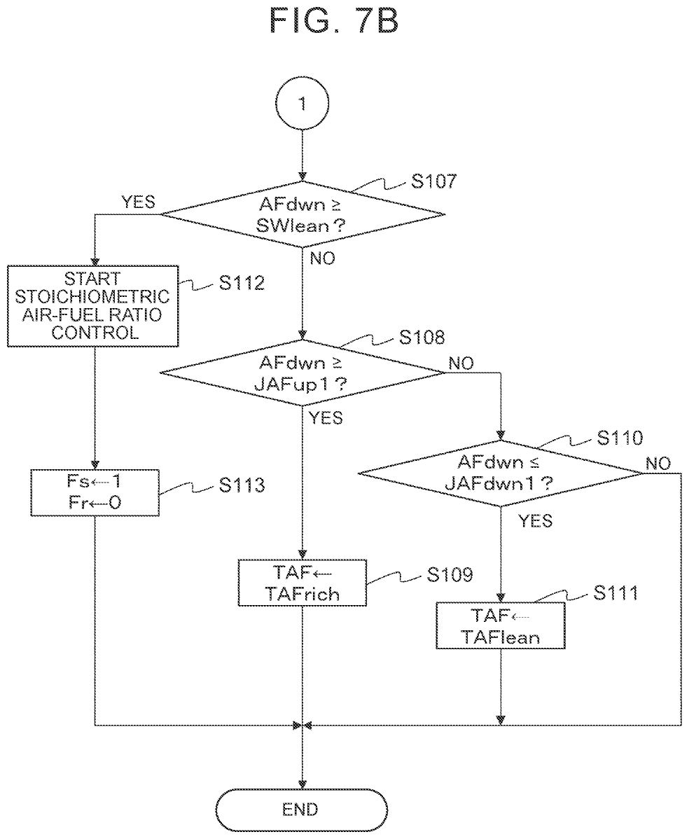

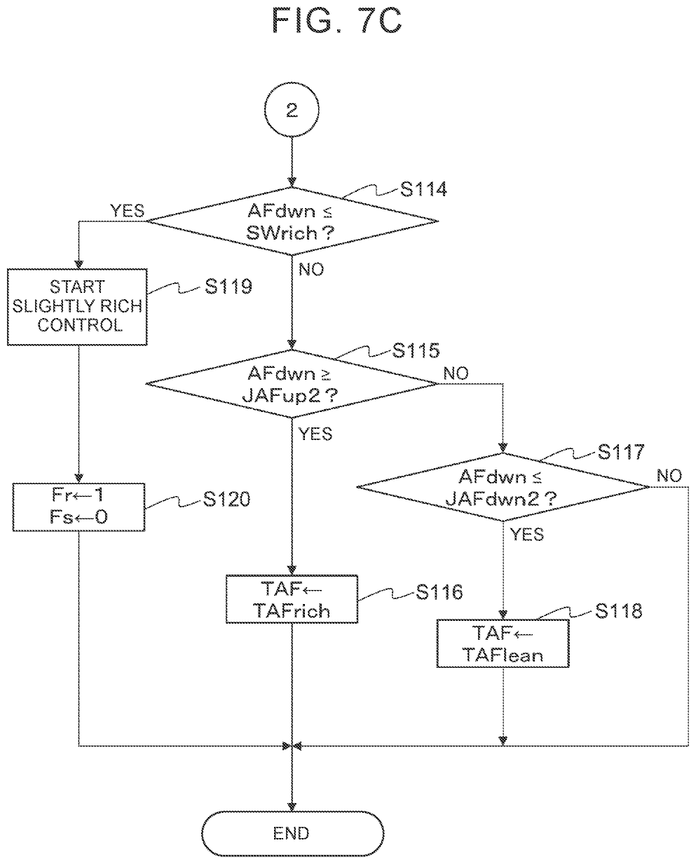

The air-fuel ratio control discussed above will be described in detail below with reference to the flowcharts in FIGS. 7A to 7C. FIGS. 7A to 7C are flowcharts illustrating the control routine of the air-fuel ratio control according to the first embodiment. The present control routine is executed repeatedly at predetermined execution intervals by the ECU 31 that functions as the air-fuel ratio control device.

First, in step S101, the air-fuel ratio control device determines whether a condition for executing the air-fuel ratio control is met. The condition for executing the air-fuel ratio control is met when the temperature of the catalyst 20 is equal to or more than a predetermined activation temperature and the element temperature of the upstream air-fuel ratio sensor 41 and the downstream air-fuel ratio sensor 42 is equal to or more than a predetermined activation temperature, for example. The temperature of the catalyst 20 is calculated based on an output from a temperature sensor provided in the catalyst 20 or the exhaust passage in the vicinity of the catalyst 20, or calculated based on a predetermined state quantity of the internal combustion engine (e.g. engine coolant temperature, intake air amount, engine load, etc.), for example. The element temperature of the upstream air-fuel ratio sensor 41 and the downstream air-fuel ratio sensor 42 is calculated based on the impedance of a sensor element, for example. The condition for executing the air-fuel ratio control may be met when a predetermined time has elapsed since the internal combustion engine is started, when a predetermined component (such as the fuel injection valve 11, the catalyst 20, the upstream air-fuel ratio sensor 41, or the downstream air-fuel ratio sensor 42) of the internal combustion engine is normal, etc.

When it is determined in step S101 that the condition for executing the air-fuel ratio control is not met, the present control routine is ended. When it is determined in step S101 that the condition for executing the air-fuel ratio control is met, on the other hand, the present control routine proceeds to step S102.

In step S102, the air-fuel ratio control device determines whether a rich flag Fr is set to 1. The rich flag Fr is a flag that is set to 1 when the slightly rich control is started, and that is set to zero when the slightly rich control is ended. The initial value of the rich flag Fr at the time when the internal combustion engine is started is zero. When it is determined in step S102 that the rich flag Fr is set to zero, the present control routine proceeds to step S103.

In step S103, the air-fuel ratio control device determines whether a stoichiometric flag Fs is set to 1. The stoichiometric flag Fs is a flag that is set to 1 when the stoichiometric air-fuel ratio control is started, and that is set to zero when the stoichiometric air-fuel ratio control is ended. The initial value of the stoichiometric flag Fs at the time when the internal combustion engine is started is zero. When it is determined in step S103 that the stoichiometric flag Fs is set to zero, the present control routine proceeds to step S104.

In step S104, the air-fuel ratio control device starts the slightly rich control. That is, the air-fuel ratio control device sets the target output value for the downstream air-fuel ratio sensor 42 to the slightly rich setting air-fuel ratio. The slightly rich setting air-fuel ratio is set to an air-fuel ratio that is determined in advance and that is slightly richer than the stoichiometric air-fuel ratio. The slightly rich setting air-fuel ratio is set to 14.50 to 14.58, preferably 14.58, for example.

Then, in step S105, the air-fuel ratio control device sets a target air-fuel ratio TAF for the in-flow exhaust gas to the lean setting air-fuel ratio TAFlean. That is, the air-fuel ratio control device performs feedback control in which the air-fuel ratio of the in-flow exhaust gas is brought to the lean setting air-fuel ratio TAFlean based on the output from the upstream air-fuel ratio sensor 41. The lean setting air-fuel ratio TAFlean is set to an air-fuel ratio (e.g. 14.7 to 15.7) that is determined in advance and that is leaner than the stoichiometric air-fuel ratio.

Then, in step S106, the air-fuel ratio control device sets the rich flag Fr to 1, and the present control routine proceeds to step S107. When the slightly rich control has already been executed at the time of start of the control routine, on the other hand, it is determined in step S102 that the rich flag Fr is set to 1, and the present control routine proceeds to step S107 by skipping steps S103 to S106.

In step S107, the air-fuel ratio control device determines whether an output air-fuel ratio AFdwn of the downstream air-fuel ratio sensor 42 is equal to or more than the lean-side switching air-fuel ratio SWlean. The lean-side switching air-fuel ratio SWlean is set to a value that is determined in advance and that is equal to or more than the stoichiometric air-fuel ratio. The lean-side switching air-fuel ratio SWlean is set to 14.60 to 14.65, preferably set to the stoichiometric air-fuel ratio (14.60), for example. When it is determined in step S107 that the output air-fuel ratio AFdwn of the downstream air-fuel ratio sensor 42 is less than the lean-side switching air-fuel ratio SWlean, the present control routine proceeds to step S108, and the slightly rich control is continued.

In step S108, the air-fuel ratio control device determines whether the output air-fuel ratio AFdwn of the downstream air-fuel ratio sensor 42 is equal to or more than the first upper determination air-fuel ratio JAFup1. The first upper determination air-fuel ratio JAFup1 is set to an air-fuel ratio that is determined in advance and that is richer than the stoichiometric air-fuel ratio and slightly leaner than the slightly rich setting air-fuel ratio. The first upper determination air-fuel ratio JAFup1 is set to a value that is more than the slightly rich setting air-fuel ratio by 0.01, and set to 14.59 when the slightly rich setting air-fuel ratio is 14.58, for example.

When it is determined in step S108 that the output air-fuel ratio AFdwn of the downstream air-fuel ratio sensor 42 is equal to or more than the first upper determination air-fuel ratio JAFup1, the present control routine proceeds to step S109. In step S109, the air-fuel ratio control device sets the target air-fuel ratio TAF for the in-flow exhaust gas to the rich setting air-fuel ratio TAFrich. That is, the air-fuel ratio control device performs feedback control in which the air-fuel ratio of the in-flow exhaust gas is brought to the rich setting air-fuel ratio TAFrich based on the output from the upstream air-fuel ratio sensor 41. The rich setting air-fuel ratio TAFrich is set to an air-fuel ratio (e.g. 13.5 to 14.5) that is determined in advance and that is richer than the stoichiometric air-fuel ratio. After step S109, the present control routine is ended.

When it is determined in step S108 that the output air-fuel ratio AFdwn of the downstream air-fuel ratio sensor 42 is less than the first upper determination air-fuel ratio JAFup1, on the other hand, the present control routine proceeds to step S110. In step S110, the air-fuel ratio control device determines whether the output air-fuel ratio AFdwn of the downstream air-fuel ratio sensor 42 is equal to or less than the first lower determination air-fuel ratio JAFdwn1. The first lower determination air-fuel ratio JAFdwn1 is set to an air-fuel ratio that is determined in advance and that is slightly richer than the slightly rich setting air-fuel ratio. The first lower determination air-fuel ratio JAFdwn1 is set to a value that is less than the slightly rich setting air-fuel ratio by 0.01, and set to 14.57 when the slightly rich setting air-fuel ratio is 14.58, for example.

When it is determined in step S110 that the output air-fuel ratio AFdwn of the downstream air-fuel ratio sensor 42 is more than the first lower determination air-fuel ratio JAFdwn1, the present control routine is ended, and the target air-fuel ratio TAF for the in-flow exhaust gas is maintained at the present set value. When it is determined in step S110 that the output air-fuel ratio AFdwn of the downstream air-fuel ratio sensor 42 is equal to or less than the first lower determination air-fuel ratio JAFdwn1, on the other hand, the present control routine proceeds to step S111.

In step S111, the air-fuel ratio control device sets the target air-fuel ratio TAF for the in-flow exhaust gas to the lean setting air-fuel ratio TAFlean. That is, the air-fuel ratio control device performs feedback control in which the air-fuel ratio of the in-flow exhaust gas is brought to the lean setting air-fuel ratio TAFlean based on the output from the upstream air-fuel ratio sensor 41. After step S111, the present control routine is ended.

When it is determined in step S107 that the output air-fuel ratio AFdwn of the downstream air-fuel ratio sensor 42 is equal to or more than the lean-side switching air-fuel ratio SWlean, on the other hand, the present control routine proceeds to step S112. In step S112, the air-fuel ratio control device ends the slightly rich control and starts the stoichiometric air-fuel ratio control. That is, the air-fuel ratio control device sets the target output value for the downstream air-fuel ratio sensor 42 to the stoichiometric air-fuel ratio (14.60).

Then, in step S113, the air-fuel ratio control device sets the stoichiometric flag Fs to 1, and sets the rich flag Fr to zero. After step S113, the present control routine is ended. In this case, it is determined in step S103 of the next control routine that the stoichiometric flag Fs is set to 1, and the present control routine proceeds to step S114.

In step S114, the air-fuel ratio control device determines whether the output air-fuel ratio AFdwn of the downstream air-fuel ratio sensor 42 is equal to or less than the rich-side switching air-fuel ratio SWrich. The rich-side switching air-fuel ratio SWrich is set to a value that is determined in advance and that is richer than the stoichiometric air-fuel ratio. For example, the rich-side switching air-fuel ratio SWrich is set to 14.50 to 14.58, preferably set to a value (e.g. 14.58) that is equal to the slightly rich setting air-fuel ratio. When it is determined in step S114 that the output air-fuel ratio AFdwn of the downstream air-fuel ratio sensor 42 is more than the rich-side switching air-fuel ratio SWrich, the present control routine proceeds to step S115, and the stoichiometric air-fuel ratio control is continued.

In step S115, the air-fuel ratio control device determines whether the output air-fuel ratio AFdwn of the downstream air-fuel ratio sensor 42 is equal to or more than the second upper determination air-fuel ratio JAFup2. The second upper determination air-fuel ratio JAFup2 is set to an air-fuel ratio that is determined in advance and that is slightly leaner than the stoichiometric air-fuel ratio. The second upper determination air-fuel ratio JAFup2 is set to a value (14.61) that is more than the stoichiometric air-fuel ratio by 0.01, for example.

When it is determined in step S115 that the output air-fuel ratio AFdwn of the downstream air-fuel ratio sensor 42 is equal to or more than the second upper determination air-fuel ratio JAFup2, the present control routine proceeds to step S116. In step S116, the air-fuel ratio control device sets the target air-fuel ratio TAF for the in-flow exhaust gas to the rich setting air-fuel ratio TAFrich. That is, the air-fuel ratio control device performs feedback control in which the air-fuel ratio of the in-flow exhaust gas is brought to the rich setting air-fuel ratio TAFrich based on the output from the upstream air-fuel ratio sensor 41. After step S116, the present control routine is ended.

When it is determined in step S115 that the output air-fuel ratio AFdwn of the downstream air-fuel ratio sensor 42 is less than the second upper determination air-fuel ratio JAFup2, on the other hand, the present control routine proceeds to step S117. In step S117, the air-fuel ratio control device determines whether the output air-fuel ratio AFdwn of the downstream air-fuel ratio sensor 42 is equal to or less than the second lower determination air-fuel ratio JAFdwn2. The second lower determination air-fuel ratio JAFdwn2 is set to an air-fuel ratio that is determined in advance and that is slightly richer than the stoichiometric air-fuel ratio. The second upper determination air-fuel ratio JAFup2 is set to a value (14.59) that is less than the stoichiometric air-fuel ratio by 0.01, for example.

When it is determined in step S117 that the output air-fuel ratio AFdwn of the downstream air-fuel ratio sensor 42 is more than the second lower determination air-fuel ratio JAFdwn2, the present control routine is ended, and the target air-fuel ratio TAF for the in-flow exhaust gas is maintained at the present set value. When it is determined in step S117 that the output air-fuel ratio AFdwn of the downstream air-fuel ratio sensor 42 is equal to or less than the second lower determination air-fuel ratio JAFdwn2, on the other hand, the present control routine proceeds to step S118.

In step S118, the air-fuel ratio control device sets the target air-fuel ratio TAF for the in-flow exhaust gas to the lean setting air-fuel ratio TAFlean. That is, the air-fuel ratio control device performs feedback control in which the air-fuel ratio of the in-flow exhaust gas is brought to the lean setting air-fuel ratio TAFlean based on the output from the upstream air-fuel ratio sensor 41. After step S118, the present control routine is ended.

When it is determined in step S114 that the output air-fuel ratio AFdwn of the downstream air-fuel ratio sensor 42 is equal to or less than the rich-side switching air-fuel ratio SWrich, on the other hand, the present control routine proceeds to step S119. In step S119, the air-fuel ratio control device ends the stoichiometric air-fuel ratio control and starts the slightly rich control. That is, the air-fuel ratio control device sets the target output value for the downstream air-fuel ratio sensor 42 to the slightly rich setting air-fuel ratio.

Then, in step S120, the air-fuel ratio control device sets the rich flag Fr to 1, and sets the stoichiometric flag Fs to zero. After step S120, the present control routine is ended.

In at least one of steps S108 and S115, the air-fuel ratio control device may determine whether the elapsed time, the integral intake air amount, etc. since the target air-fuel ratio TAF for the in-flow exhaust gas is set to the lean setting air-fuel ratio TAFlean has reached a predetermined threshold. That is, in at least one of the slightly rich control and the stoichiometric air-fuel ratio control, the air-fuel ratio control device may switch the target air-fuel ratio TAF for the in-flow exhaust gas from the lean setting air-fuel ratio TAFlean to the rich setting air-fuel ratio TAFrich when the elapsed time, the integral intake air amount, etc. since the target air-fuel ratio TAF for the in-flow exhaust gas is set to the lean setting air-fuel ratio TAFlean has reached the predetermined threshold.

In at least one of steps S110 and S117, the air-fuel ratio control device may determine whether the elapsed time, the integral intake air amount, etc. since the target air-fuel ratio TAF for the in-flow exhaust gas is set to the rich setting air-fuel ratio TAFrich has reached a predetermined threshold. That is, in at least one of the slightly rich control and the stoichiometric air-fuel ratio control, the air-fuel ratio control device may switch the target air-fuel ratio TAF for the in-flow exhaust gas from the rich setting air-fuel ratio TAFrich to the lean setting air-fuel ratio TAFlean when the elapsed time, the integral intake air amount, etc. since the target air-fuel ratio TAF for the in-flow exhaust gas is set to the rich setting air-fuel ratio TAFrich has reached the predetermined threshold.

It is considered that the amount of oxygen occluded in the catalyst 20 has not reached the maximum value when the internal combustion engine is started. Therefore, in the control routine described above, the slightly rich control is executed as the initial air-fuel ratio control after the internal combustion engine is started. However, the stoichiometric air-fuel ratio control may be executed as the initial air-fuel ratio control after the internal combustion engine is started. The air-fuel ratio control device may perform feedback control of the air-fuel ratio of the in-flow exhaust gas based on the output from the upstream air-fuel ratio sensor 41 such that the air-fuel ratio of the in-flow exhaust gas coincides with a predetermined value (e.g. the stoichiometric air-fuel ratio) as the initial air-fuel ratio control after the internal combustion engine is started. In this case, the slightly rich control is started when the output air-fuel ratio AFdwn of the downstream air-fuel ratio sensor 42 is reduced to be equal to or less than the rich-side switching air-fuel ratio SWrich in the initial air-fuel ratio control, and the stoichiometric air-fuel ratio control is started when the output air-fuel ratio AFdwn of the downstream air-fuel ratio sensor 42 is increased to be equal to or more than the lean-side switching air-fuel ratio SWlean in the initial air-fuel ratio control.

Next, a second embodiment of the present disclosure will be described. The configuration and the control of the exhaust gas control apparatus according to the second embodiment are basically the same as those of the exhaust gas control apparatus according to the first embodiment except for the points described below. Therefore, the second embodiment of the present disclosure will be described below mainly for differences from the first embodiment.

In the slightly rich control, as discussed above, the target output value for the downstream air-fuel ratio sensor 42 is set to the slightly rich setting air-fuel ratio, and a fixed value determined in advance is used as the value of the slightly rich setting air-fuel ratio in the first embodiment. However, the amount of hydrogen generated in the catalyst 20 may be fluctuated in accordance with the air-fuel ratio of the in-flow exhaust gas and the state of the catalyst 20. Basically, as the amount of hydrogen that flows out of the catalyst 20 becomes larger, the deviation in the output from the downstream air-fuel ratio sensor 42 becomes larger, and the output air-fuel ratio of the downstream air-fuel ratio sensor 42 becomes richer.

Thus, in the second embodiment, the air-fuel ratio control device determines the degree of richness of the slightly rich setting air-fuel ratio based on a minimum air-fuel ratio at the time when the output air-fuel ratio of the downstream air-fuel ratio sensor 42 has been reduced to be equal to or less than the rich-side switching air-fuel ratio. Consequently, it is possible to set the target output value for the downstream air-fuel ratio sensor 42 in the slightly rich control to a value that is suitable for the amount of hydrogen that flows out of the catalyst 20, and hence to effectively suppress degradation in exhaust emission. The degree of richness of the slightly rich setting air-fuel ratio means the difference between the slightly rich setting air-fuel ratio set as a value that is richer than the stoichiometric air-fuel ratio and the stoichiometric air-fuel ratio. The slightly rich setting air-fuel ratio becomes richer as the degree of richness of the slightly rich setting air-fuel ratio becomes higher.

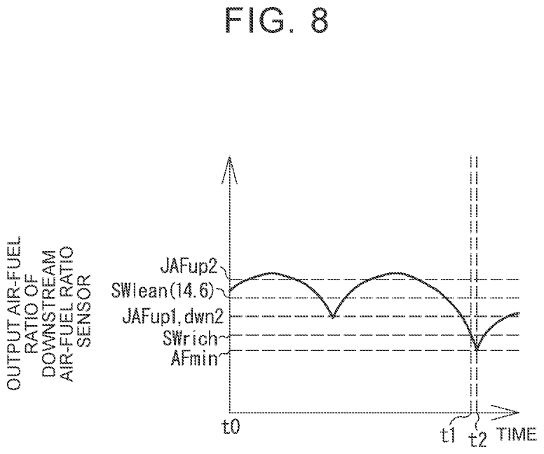

FIG. 8 illustrates a minimum air-fuel ratio at the time when the output air-fuel ratio of the downstream air-fuel ratio sensor 42 is reduced to be equal to or less than the rich-side switching air-fuel ratio. FIG. 8 is a time chart of the output air-fuel ratio of the downstream air-fuel ratio sensor 42. At time t1, the output air-fuel ratio of the downstream air-fuel ratio sensor 42 has been reduced to the rich-side switching air-fuel ratio SWrich. The output air-fuel ratio of the downstream air-fuel ratio sensor 42 is continuously reduced also after time t1, and becomes minimum at time t2. The output air-fuel ratio of the downstream air-fuel ratio sensor 42 at time t2 corresponds to the minimum air-fuel ratio (AFmin) at the time when the output air-fuel ratio of the downstream air-fuel ratio sensor 42 is reduced to be equal to or less than the rich-side switching air-fuel ratio SWrich.

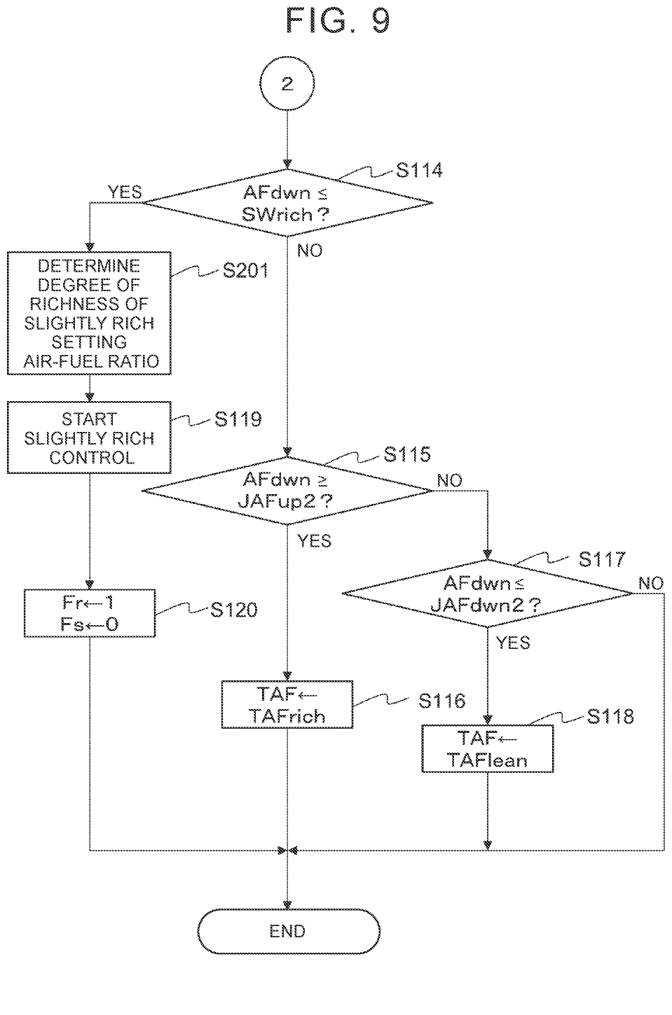

While the flowcharts in FIGS. 7A to 7C are used as the control routine of the air-fuel ratio control in the first embodiment, flowcharts in FIGS. 7A, 7B, and 9 are used as the control routine of the air-fuel ratio control in the second embodiment. That is, in the second embodiment, when it is determined in step S114 that the output air-fuel ratio AFdwn of the downstream air-fuel ratio sensor 42 is equal to or less than the rich-side switching air-fuel ratio SWrich, step S201 is executed before step S119.

In step S201, the air-fuel ratio control device determines the degree of richness of the slightly rich setting air-fuel ratio in the slightly rich control based on the minimum air-fuel ratio (hereinafter simply referred to as a “minimum air-fuel ratio”) at the time when the output air-fuel ratio AFdwn of the downstream air-fuel ratio sensor 42 is reduced to be equal to or less than the rich-side switching air-fuel ratio SWrich. Specifically, the air-fuel ratio control device increases the degree of richness of the slightly rich setting air-fuel ratio as the minimum air-fuel ratio is lower (richer). The air-fuel ratio control device changes the values of the first upper determination air-fuel ratio JAFup1 and the first lower determination air-fuel ratio JAFdwn1 in accordance with the set value of the slightly rich setting air-fuel ratio. As the slightly rich setting air-fuel ratio is richer, the values of the first upper determination air-fuel ratio JAFup1 and the first lower determination air-fuel ratio JAFdwn1 are also rendered richer.

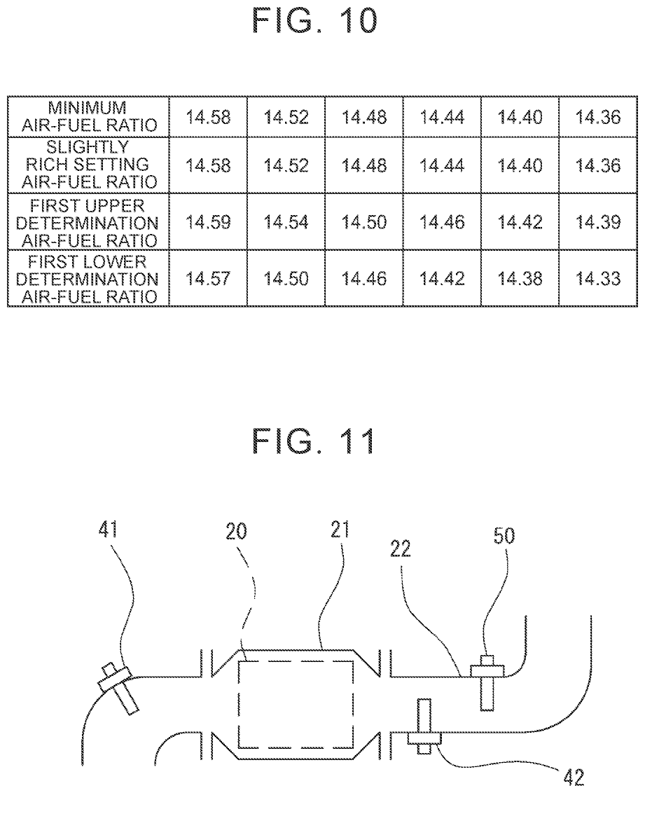

For example, the air-fuel ratio control device determines the slightly rich setting air-fuel ratio and the values of the first upper determination air-fuel ratio JAFup1 and the first lower determination air-fuel ratio JAFdwn1 based on the minimum air-fuel ratio using a map or a calculation formula. FIG. 10 illustrates an example of a map for determining the slightly rich setting air-fuel ratio and the values of the first upper determination air-fuel ratio JAFup1 and the first lower determination air-fuel ratio JAFdwn1 based on the minimum air-fuel ratio. In the map in FIG. 10, the slightly rich setting air-fuel ratio is rendered richer as the minimum air-fuel ratio is richer. As the minimum air-fuel ratio is richer, the difference between the slightly rich setting air-fuel ratio and the first upper determination air-fuel ratio JAFup1 and the difference between the slightly rich setting air-fuel ratio and the first lower determination air-fuel ratio JAFdwn1 are rendered larger.

After step S201, the slightly rich control is started in step S119, and the values determined in step S201 are used as the value of the first upper determination air-fuel ratio JAFup1 in step S108 in FIG. 7B and the value of the first lower determination air-fuel ratio JAFdwn1 in step S110 in FIG. 7B.

Next, a third embodiment of the present disclosure will be described. The configuration and the control of the exhaust gas control apparatus according to the third embodiment are basically the same as those of the exhaust gas control apparatus according to the first embodiment except for the points described below. Therefore, the third embodiment of the present disclosure will be described below mainly for differences from the first embodiment.

FIG. 11 schematically illustrates a part of an internal combustion engine with an exhaust gas control apparatus for an internal combustion engine according to the third embodiment of the present disclosure. In the third embodiment, a hydrogen sensor 50 is disposed in the exhaust passage (specifically the exhaust pipe 22) downstream of the catalyst 20, in addition to the downstream air-fuel ratio sensor 42. The hydrogen sensor 50 detects the concentration of hydrogen in an exhaust gas that flows in the exhaust pipe 22, that is, an exhaust gas that flows out of the catalyst 20. The hydrogen sensor 50 is electrically connected to the ECU 31 (see FIG. 1). An output from the hydrogen sensor 50 is input to the input port 36 via a corresponding AD converter 38.

Basically, as discussed above in relation to the second embodiment, as the amount of hydrogen that flows out of the catalyst 20 becomes larger, the deviation in the output from the downstream air-fuel ratio sensor 42 becomes larger, and the output air-fuel ratio of the downstream air-fuel ratio sensor 42 becomes richer. Thus, in the third embodiment, the air-fuel ratio control device estimates the concentration of hydrogen in the out-flow exhaust gas based on the output from the hydrogen sensor 50, and determines the degree of richness of the slightly rich setting air-fuel ratio based on the hydrogen concentration. Consequently, it is possible to set the target output value for the downstream air-fuel ratio sensor 42 in the slightly rich control to a value that is suitable for the amount of hydrogen that flows out of the catalyst 20, and hence to effectively suppress degradation in exhaust emission.

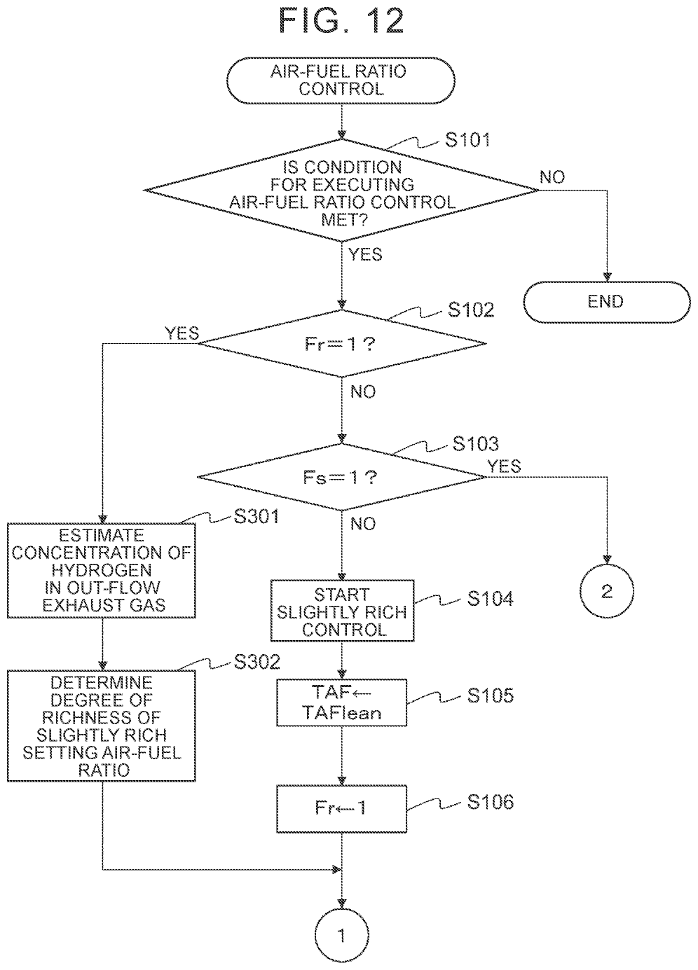

While the flowcharts in FIGS. 7A to 7C are used as the control routine of the air-fuel ratio control in the first embodiment, flowcharts in FIGS. 12, 7B, and 7C are used as the control routine of the air-fuel ratio control in the third embodiment. That is, in the third embodiment, when it is determined in step S102 that the rich flag Fr is set to 1, steps S301 and S302 are executed before step S107 in FIG. 7B.

In step S301, the air-fuel ratio control device estimates the concentration of hydrogen in the out-flow exhaust gas based on the output from the hydrogen sensor 50.

Then, in step S302, the air-fuel ratio control device determines the degree of richness of the slightly rich setting air-fuel ratio in the slightly rich control based on the concentration of hydrogen in the out-flow exhaust gas. Specifically, the air-fuel ratio control device increases the degree of richness of the slightly rich setting air-fuel ratio as the concentration of hydrogen in the out-flow exhaust gas is higher. The air-fuel ratio control device changes the values of the first upper determination air-fuel ratio JAFup1 and the first lower determination air-fuel ratio JAFdwn1 in accordance with the set value of the slightly rich setting air-fuel ratio. As the slightly rich setting air-fuel ratio is richer, the values of the first upper determination air-fuel ratio JAFup1 and the first lower determination air-fuel ratio JAFdwn1 are also rendered richer. For example, the air-fuel ratio control device determines the slightly rich setting air-fuel ratio and the values of the first upper determination air-fuel ratio JAFup1 and the first lower determination air-fuel ratio JAFdwn1 based on the concentration of hydrogen in the out-flow exhaust gas using a map or a calculation formula.

After step S302, steps S107 to S111 in FIG. 7B are executed as in the first embodiment, and the values determined in step S302 are used as the value of the first upper determination air-fuel ratio JAFup1 in step S108 and the value of the first lower determination air-fuel ratio JAFdwn1 in step S110.

The air-fuel ratio control device may estimate the concentration of hydrogen in the out-flow exhaust gas based on a predetermined state quantity of the internal combustion engine using a map or a calculation formula, instead of using the hydrogen sensor 50. Examples of the predetermined state quantity include the engine rotational speed, the intake air amount, the air-fuel ratio of the in-flow exhaust gas, the temperature of the in-flow exhaust gas, the oxygen occlusion capability of the catalyst 20, the EGR rate (when the internal combustion engine is provided with a component that recirculates the EGR gas), etc. Such predetermined state quantities are calculated by a known method based on outputs from the various sensors (such as the crank angle sensor 45, the air flow meter 40, the upstream air-fuel ratio sensor 41, and an exhaust temperature sensor (not illustrated)).

The air-fuel ratio control device may estimate the concentration of hydrogen in the out-flow exhaust gas using a regression model trained in advance so as to output the concentration of hydrogen in the out-flow exhaust gas based on a predetermined state quantity of the internal combustion engine. Examples of such a regression model include machine learning models such as neural networks, support vector machines, and random forests.

While steps S301 and S302 are executed between steps S102 and S107 in the control routine described above, steps S301 and S302 may be executed between steps S102 and S106 and step S107.

Other embodiments will be described below. While preferable embodiments of the present disclosure have been described above, the present disclosure is not limited to such embodiments, and various modifications and changes may be made within the scope of the claims. For example, a downstream catalyst that is similar to the catalyst 20 may be disposed in the exhaust passage downstream of the catalyst 20 in the internal combustion engine.

In the slightly rich control, the air-fuel ratio control device may perform feedback control of the target air-fuel ratio for the in-flow exhaust gas based on the output from the downstream air-fuel ratio sensor 42 such that the output air-fuel ratio of the downstream air-fuel ratio sensor 42 coincides with the slightly rich setting air-fuel ratio, instead of switching the target air-fuel ratio for the in-flow exhaust gas between the rich setting air-fuel ratio and the lean setting air-fuel ratio. Likewise, in the stoichiometric air-fuel ratio control, the air-fuel ratio control device may perform feedback control of the target air-fuel ratio for the in-flow exhaust gas based on the output from the downstream air-fuel ratio sensor 42 such that the output air-fuel ratio of the downstream air-fuel ratio sensor 42 coincides with the stoichiometric air-fuel ratio, instead of switching the target air-fuel ratio for the in-flow exhaust gas between the rich setting air-fuel ratio and the lean setting air-fuel ratio. The air-fuel ratio control device may execute air-fuel ratio control that is different from the stoichiometric air-fuel ratio control when the slightly rich control is not executed.

What is claimed is:

1. An exhaust gas control apparatus for an internal combustion engine, comprising:
a catalyst disposed in an exhaust passage of the internal combustion engine and configured to be able to occlude oxygen;
an air-fuel ratio sensor configured to detect an air-fuel ratio of an out-flow exhaust gas that flows out of the catalyst; and
an air-fuel ratio control device configured to control an air-fuel ratio of an in-flow exhaust gas that flows into the catalyst, wherein the air-fuel ratio control device starts slightly rich control in which the air-fuel ratio of the in-flow exhaust gas is controlled such that the air-fuel ratio of the out-flow exhaust gas detected by the air-fuel ratio sensor is maintained at a slightly rich setting air-fuel ratio that is richer than a stoichiometric air-fuel ratio, when the air-fuel ratio of the out-flow exhaust gas detected by the air-fuel ratio sensor is reduced to be equal to or less than a rich-side switching air-fuel ratio that is richer than the stoichiometric air-fuel ratio.

2. The exhaust gas control apparatus for an internal combustion engine according to claim 1, wherein the air-fuel ratio control device is configured to start the slightly rich control when the air-fuel ratio of the out-flow exhaust gas detected by the air-fuel ratio sensor is reduced to be equal to or less than the rich-side switching air-fuel ratio while the air-fuel ratio of the in-flow exhaust gas is controlled such that the air-fuel ratio of the out-flow exhaust gas detected by the air-fuel ratio sensor is maintained at the stoichiometric air-fuel ratio or more.

3. The exhaust gas control apparatus for an internal combustion engine according to claim 1, wherein:
the air-fuel ratio control device is configured to execute stoichiometric air-fuel ratio control in which the air-fuel ratio of the in-flow exhaust gas is controlled such that the air-fuel ratio of the out-flow exhaust gas detected by the air-fuel ratio sensor is maintained at the stoichiometric air-fuel ratio; and
the air-fuel ratio control device is configured to start the slightly rich control when the air-fuel ratio of the out-flow exhaust gas detected by the air-fuel ratio sensor is reduced to be equal to or less than the rich-side switching air-fuel ratio in the stoichiometric air-fuel ratio control.

4. The exhaust gas control apparatus for an internal combustion engine according to claim 1, wherein the air-fuel ratio control device is configured to end the slightly rich control when the air-fuel ratio of the out-flow exhaust gas detected by the air-fuel ratio sensor is increased to be equal to or more than a lean-side switching air-fuel ratio that is equal to or more than the stoichiometric air-fuel ratio in the slightly rich control.

5. The exhaust gas control apparatus for an internal combustion engine according to claim 4, wherein the air-fuel ratio control device is configured to start stoichiometric air-fuel ratio control in which the air-fuel ratio of the in-flow exhaust gas is controlled such that the air-fuel ratio of the out-flow exhaust gas detected by the air-fuel ratio sensor is maintained at the stoichiometric air-fuel ratio when the air-fuel ratio of the out-flow exhaust gas detected by the air-fuel ratio sensor is increased to be equal to or more than the lean-side switching air-fuel ratio in the slightly rich control.

6. The exhaust gas control apparatus for an internal combustion engine according to claim 1, wherein the air-fuel ratio control device is configured to determine a degree of richness of the slightly rich setting air-fuel ratio based on a minimum air-fuel ratio at a time when the air-fuel ratio of the out-flow exhaust gas detected by the air-fuel ratio sensor is reduced to be equal to or less than the rich-side switching air-fuel ratio.

7. The exhaust gas control apparatus for an internal combustion engine according to claim 1, wherein the air-fuel ratio control device is configured to estimate a concentration of hydrogen in the out-flow exhaust gas, and determine a degree of richness of the slightly rich setting air-fuel ratio based on the hydrogen concentration.

8. An exhaust gas control method for an internal combustion engine, the internal combustion engine including a catalyst disposed in an exhaust passage of the internal combustion engine and configured to be able to occlude oxygen, an air-fuel ratio sensor configured to detect an air-fuel ratio of an out-flow exhaust gas that flows out of the catalyst, and an air-fuel ratio control device configured to control an air-fuel ratio of an in-flow exhaust gas that flows into the catalyst, the exhaust gas control method comprising starting slightly rich control in which the air-fuel ratio of the in-flow exhaust gas is controlled such that the air-fuel ratio of the out-flow exhaust gas detected by the air-fuel ratio sensor is maintained at a slightly rich setting air-fuel ratio that is richer than a stoichiometric air-fuel ratio, when the air-fuel ratio of the out-flow exhaust gas detected by the air-fuel ratio sensor is reduced to be equal to or less than a rich-side switching air-fuel ratio that is richer than the stoichiometric air-fuel ratio.
